(19) United States
(12) Patent Application Publication
(10) Pub. No.: US 2005/0251407 A1
(43) Pub. Date: Nov. 10, 2005

(54) Method, system, and service for determining actual and probable financial loss related to internet performance anomalies

(76) Inventors: John S. Quarterman, Lancaster, NY (US); Gretchen K. Phillips, Lancaster, NY (US)

Correspondence Address: Simpson & Simpson, PLLC, 5555 Main Street, Williamsville, NY, 14221-5406, US

(21) Appl. No.: 11/087,238

(22) Filed: Mar. 23, 2005

Related U.S. Application Data
(60) Provisional application No. 60/555,441, filed on Mar. 23, 2004.

(51) Int. Cl. G06F 17/60

(52) U.S. Cl. 705/1

(57) ABSTRACT

The invention broadly comprises a method for determining financial loss related to performance of an internetwork. The method correlates input information regarding performance of an internetwork to operations of a financial entity and translates the correlated input information into a first at least one operational risk for the financial entity. In some aspects, the internetwork is the Internet. The method translates the correlated input information into a first Probability of Default. The method also gathers secondary information, where the secondary information is other than directly from the internetwork, correlates the input and secondary information, and translates the correlated input and secondary information into a second at least one operational risk for the financial entity. In some aspects, the method calculates a second Probability of Default, a Loss Given Default, an Exposure at Default, and a Maturity.

### CROSS-REFERENCE TO RELATED APPLICATIONS

This application claims the benefit under 35 U.S.C. §119(e) of U.S. Provisional Application No. 60/555,441, filed Mar. 23, 2004.

### FIELD OF THE INVENTION

The invention relates to computer network performance and financial risk management, and more particularly, to a method to determine financial risk related to Internet performance perils and anomalies.

### BACKGROUND OF THE INVENTION

Commerce continues to embrace the Internet and to become dependent upon it. In banking in particular, deposits, withdrawals, balances, statements, lines of credit, and other financial transactions and instruments are increasingly available via and used over the Internet.

Operational risks in a bank's context have to be quantified in correlation to the infrastructure that the bank engages when it joins a specific logical network topology. Further, the characterization of that topology and its inherent risks must be kept current since risks on the Internet are contemporaneous to conditions, which change from moment to moment.

In addition to changes in configuration by the providers of the Internet, banking use of the Internet is susceptible to the same congestion, misconfigurations, accidents, natural disasters, terrorism, and vandalism that can affect anything else on the Internet. Meanwhile banks have increased outsourcing, which requires networks, and introduces counter party risk including not only the outsourced unit, but also the intervening components of the Internet (Internet Service Providers, exchanges, routers, and links) and the various governmental regimes through which those components pass. Banks have also increased automation, which requires automated monitoring and reporting. The Internet is central in modern international banking; international banking needs to quantify (measure, test, verify, maintain, and administer) Internet risk.

International banks have recognized parts of this situation in the New Basel Capital Accord, also known as the New Accord or Basel II, which requires quantification of operational risk, including on-going operational measurement, monitoring, alerting, and reporting. The U.S. Federal Reserve Staff have published a document on U.S. Basel II Implementation, Federal Reserve Docket No. ?, 12 CFR Parts 208 and 225, Regulations H and Y; OCC Docket No. 03-XX, 12 CFR Part 3, RIN Number 1557-AB14; FDIC 12 CFR Part 325, RIN ?; OTS Docket No. ?, 12 CFR Part 567, RIN ?.

While Basel II spells out methods of quantifying credit risk, it does not specify detailed methods of quantifying operational risk, especially not of operational risk related to the Internet. Basel II recognizes a number of relevant types of operational risk, but it does not directly relate them to perils (hazards or dangers) and anomalies (harm, loss, or injuries) on the Internet. The following are examples of operational risk types, with some corresponding types of Internet operational risk for each: service provisioning, due diligence, and scenario analysis: picking appropriate ISPs and siting appropriate servers; loss or damage to physical assets due to natural disaster or other events: e.g., Hurricane Floyd or 9/11; business disruption and system failures: denial of service (DoS) attacks, worms, operating system design failures, and inadequate application of patches (these perils and anomalies are also known as vulnerabilities and exploits in traditional Internet security terminology); and, failed transaction processing or process management involving trade counterparties or vendors: congestion, routing flaps, and other degradation of service between an entity and counterparties, as well as the ISPs conveying the service, and deployment choices of counterparties.

Thus, there has been a long felt need for an ongoing service for quantifying operational risk of banking uses of the Internet and for translating the results into terms that banks can use to manage risks relevant to their business.

### SUMMARY OF THE INVENTION

The invention broadly comprises a method for determining financial loss related to performance of an internetwork. The method correlates input information regarding performance of an internetwork to operations of a financial entity and translates the correlated input information into a first at least one operational risk for the financial entity. In some aspects, the internetwork is the Internet. In some aspects, the internetwork comprises at least one anomaly and the method collects the input information using techniques that simultaneously record topology and performance, detects the at least one anomaly in at least one portion of the internetwork, and characterizes the at least one anomaly by type, severity, duration, and effect.

The method translates the correlated input information into a first Probability of Default. The method also gathers secondary information, where the secondary information is other than directly from the internetwork, correlates the input and secondary information, and translates the correlated input and secondary information into a second at least one operational risk for the financial entity. In some aspects, the method calculates a second Probability of Default, a Loss Given Default, an Exposure at Default, and a Maturity

A general object of the present invention is to quantify operational risk of banking uses of the Internet.

Another object of the present invention is to translate quantified operational risk into terms that banks can use to manage risks relevant to their businesses.

In comparison to known prior art, the invention combines elements of network performance and of financial quantification in application to financial risk management of Internet operations.

These and other objects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing Figures in which:

FIG. 1 illustrates the steps or aspects of the present invention for determining Internet financial risk;

FIG. 2 depicts an example of an Internet financial risk, a nonredundant route; and,

FIG. 3 provides further detail regarding Figure.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

For purposes of the invention, the following financial terms or financial parameters are defined by their translations from Internet performance parameters as follows. These terms are well-defined for credit risk, yet have not previously been defined for operational risk. Once the invention produces values for these terms, they may be manipulated by banks or other parties in the same manner as the equivalent terms for credit risk, for example in computing capital withholding for Basel II. The invention also includes steps of summarization and reporting that manipulate some of these terms.

Probability of Default (PD): Calculation of PD involves determining which customers of a bank will be affected by a given type of anomaly, and then calculating how many of them will be affected, how frequently, how severely, and how long.

Loss Given Default (LGD): Calculation of LGD involves combining estimates of each customer's use of the Internet to reach the bank and the value of that use to the customer. Such value is then used to estimate how likely the customer is not to perform transactions that are delayed or interrupted by anomalies.

Exposure at Default (EAD). The invention combines the value of each customer's transactions to the bank with LGD to estimate exposure at default, which is the amount the bank stands to lose because of anomalies. The value of a customer's transaction to the bank can be twofold: the direct income to the bank in fees for the transaction or the value of customer's account to the bank (see M, below).

Maturity (M). The invention calculates Maturity (M), which is the remaining proportion of a contract or account that each banking customer has with the bank for some time into the future.

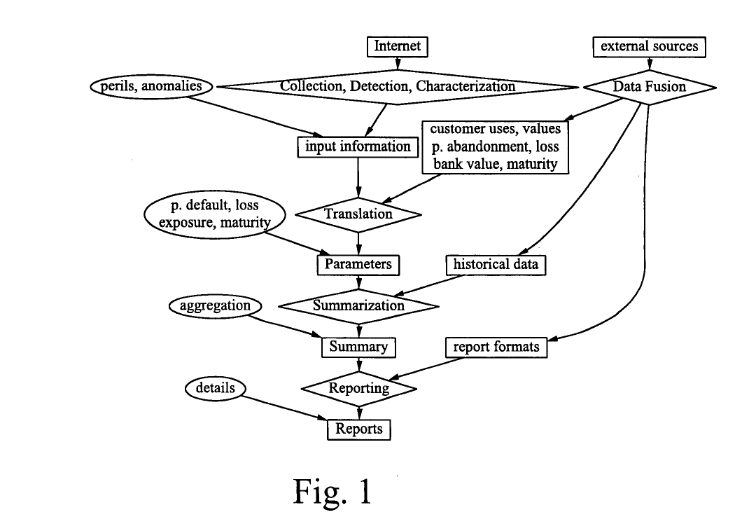

FIG. 1 illustrates the steps or aspects of the present invention for determining Internet financial risk.

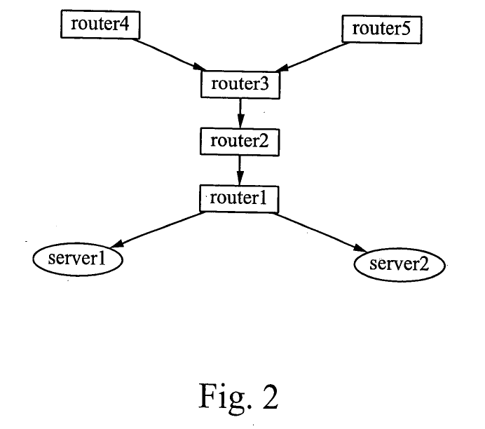

FIG. 2 depicts an example of an Internet financial risk, a nonredundant route.

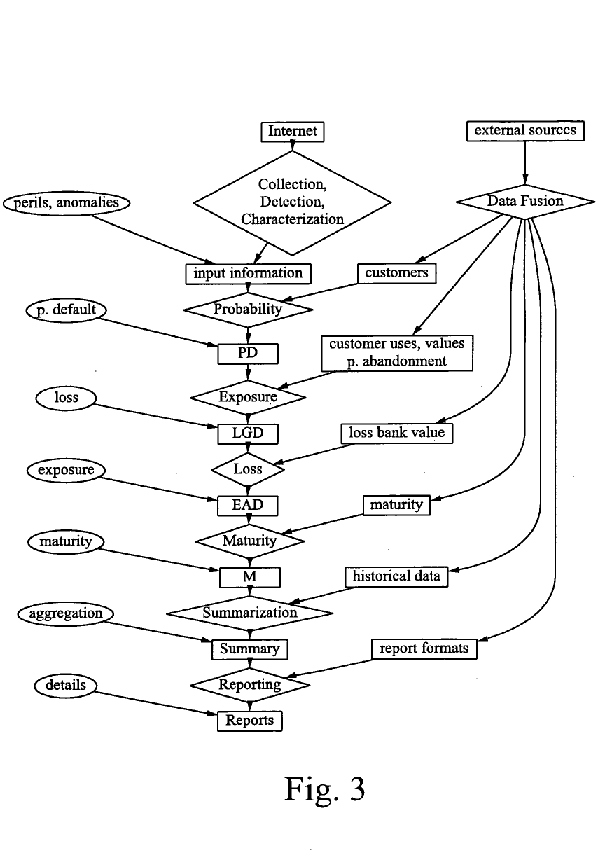

FIG. 3 provides further detail regarding FIG. 1. FIG. 3 further shows how the invention works, in particular, how the financial terms or parameters are related. The following should be viewed in light of FIGS. 1 through 3. In FIG. 2, router1, router2, and router3 are nonredundant routers on a nonredundant route to server1 and server2. If any of router1, router2, or router3 fail, server1 and server2 will be cut off from the Internet. If router4 or router5 fails, there is less likelihood that server1 or server2 will be cut off, because if router4 fails traffic could be routed through the router5, and the reverse. Such topological analysis of networks is well known in the computer science discipline of graph theory, including the recent literature about scale-free networks; yet its ongoing application to frequent and regular measurements of actual Internet topology is novel.

Even if a link or path does not completely fail, its performance may be degraded. Problems with performance of a server may produce contributory disruption to third parties with which that server shares network pathways. In FIG. 2, if server1 is being attacked by a distributed denial of service (DDOS) or being affected by a worm that is not specifically targeted at that server, the resulting excess traffic may slow down router1, which in turn can affect the perceived performance of server2 as seen by its users. Such combination of topological analysis with performance measurements and analysis is novel, and the application of such performance and topological analysis to quantification of business risk is especially novel.

The invention uses information collected directly from the Internet, also referred to as input information or primary input information that is collected and processed by any means known in the art to detect and categorize certain features. It should be understood that the invention is not limited to any particular means for producing such information the Internet. However, the invention expects the input information to have characteristics as follows; see FIG. 1. Data Collection: Appropriate data collection gathers Internet performance data using techniques that simultaneously record topology (including routes, paths, and changes over time) and performance (including loss and latency). The techniques used are able to measure a significant proportion of the critical infrastructure of the entire Internet. Anomaly Detection: Appropriate anomaly detection detects anomalies that are significant both across large parts of the Internet and in smaller parts, whether geographical, topological, or by industry. Anomaly Characterization: Appropriate anomaly characterization assigns characteristics such as type, severity, duration, and effects to each detected anomaly. Types of anomaly may include denial of service (DoS) attacks, worms, congestion, routing flaps, and other degradation, denial, or disconnection of Internet connectivity.

The invention also uses secondary external information, that is, information external to the Internet in the sense of not being collected directly from the Internet by probes or passive monitoring. FIG. 1 illustrates how the invention combines such external information with the input information in data fusion. FIG. 3 provides further detail about which external information is used at which steps of the invention. Successive financial terms may require increasing amounts of external information compared to primary information to compute, for example LGD usually requires more external information than PD, and M more than LGD. For that matter, M could be determined entirely in terms of external information, yet M is of no use for calculating Internet operational risk without the primary input information, and of little use without PD, LGD, and EAD.

The present invention includes steps or aspects of:
1. Translation into Financial Terms: Translation of Internet anomalies into financial performance parameters such as probability of default (PD), loss given default (LGD), exposure at default (EAD), and remaining economic maturity (M) of the exposure. See FIG. 3 for illustration of further detail about these translation steps.
2. Summarization for Banking Customers: Aggregation of anomalies over time for historical performance and predictions and detailed examination of specific anomalies.
3. Reporting for Banking Customers: Reporting details of specific anomalies as they occur.
4. Data Fusion: Fusion of historical and current data from carriers, enterprises, news media, and others for calibration of accuracy and reliability.

In comparison to known prior art, the invention combines elements of network performance and of financial quantification in application to financial risk management of Internet operations.

The invention involves several steps or aspects that are continually repeated with feedback loops. The invention uses primary input information from ongoing comprehensive measurement of Internet topology for nonredundancy or overload (perils), as well as of actual variations in accessibility or performance (anomalies). The invention itself analyses, aggregates, and synthesizes such data along with external information from other sources in order to translate it into relevant financial terms. The invention then summarizes those results over time, and also reports them as they occur. See FIG. 3.

Probability of Default (PD): An example peril is a nonredundant route. As noted above, a nonredundant route is one example of an Internet financial risk. A given part of the Internet may be reachable only through one path. If a router or link along that path fails, that part of the Internet will be cut off. If that route fails, that will be an anomaly in which customers reached through that route will be cut off. Topological examination such as is described for FIG. 2 can show such routes and which customers are reachable through them. The invention determines the probability of failure of such a peril by calculating the frequency of similar failures over time. For each type of peril that the invention has determined to affect banking customers, the invention then multiplies the frequency of that peril by the number of customers affected by that peril, yielding the probability of default (PD). Most of the calculation of PD can be done using the primary input information from the Internet itself. However, it is also useful to know which enterprises are customers of which banks, and that usually requires external information from the banks themselves, or from insurers, industry analysts, or other third parties; see FIG. 3.

Loss Given Default (LGD): Calculation of LGD involves combining estimates of each customer's use of the Internet to reach the bank and the value of that use to the customer. Some information about the customer's use of the Internet may be derivable from the primary input information from the Internet itself, but information about the value the customer places on such uses will normally come from external information from the bank itself, or from insurers or from other third parties; see FIG. 3. Such value is then used to estimate how likely the customer is not to perform transactions that are delayed or interrupted by anomalies. The invention then calculates the likely proportion of loss. For example, a funds transfer can be estimated to be at least as valuable to the customer as the amount of funds transferred. A sale of some stock may be estimated to be worth to the customer the dollar amount of the transaction minus any fees. If a customer cannot perform a transaction at a given time, the customer may simply perform the same transaction at a later time, in which case there is no loss given that particular default. For example, a customer trying to review a bank statement will probably simply review it on a different day. Or in some cases a customer may simply not perform that particular transaction at all. For example, a customer trying unsuccessfully to sell a stock on one day may decide not to sell it the next day, in which case the loss to the bank is whatever fees the bank would have received. However, a customer trying to sell a stock the day before a quarterly earnings announcement may not be able to obtain the same results on a different day. If earnings are down and the price of the stock goes down, the customer may lose the difference in the price of the stock. And the bank may lose the customer. So LGD for the customer is the stock price difference, while LGD for the bank may be the customer's account. LGD is calculated as a proportion, so in the bank statement example LGD for the bank is close to 0, while for the example of stock sale before earnings call the LGD for the bank is closer to 1.

Exposure at Default (EAD): The invention combines the value of each customer's transactions to the bank with LGD to estimate exposure at default, which is the amount the bank stands to lose because of anomalies. The value of the customer's transactions to the bank may be different from the value of those transactions to the customer; for example, the customer may already have other sources of the same transactions. The value of the customer to the bank may be different from the sum of the value of the customer's transactions to the bank; for example, the customer may have prestige value to the bank, or the customer may be using other resources of the bank such as customer service that are not directly compensated. Such weights to the values to the bank of transactions or customers require additional external information to compute. Setting aside such considerations, the value of a customer's transaction to the bank can be twofold: the direct dollar income to the bank in fees for the transaction or the dollar value of customer's account to the bank (see M, below). Either of these are best found using external information from the bank itself, or estimates from third parties such as insurers or industry analysts; see FIG. 3.

Maturity (M). The invention calculates Maturity (M), which is the remaining proportion of a contract or account that each banking customer has with the bank for some time into the future. Internet performance anomalies could cause a customer to cease being a customer, so the entire remaining expected income from a customer's open accounts or contracts may be at risk. Information on maturity of each customer's accounts is supplied by the bank, and is then combined with PD and LGD to produce a long-term component of EAD. In the interests of privacy, the bank can take PD and LGD for each customer and combine it with M per customer internally. Alternatively, the invention may use estimates of M from third parties, but it is likely that information about M directly from the bank holding the contract will be more precise; in either case, some external information is usually necessary to calculate M.

The invention summarizes results by aggregating estimates of probable effects over time; see FIG. 3. Such historical aggregation of Internet and financial performance over time can be useful to banks in documenting their actual performance for use in calculating financial reserves required by Basel II.

The invention reports details of specific anomalies as they occur. Such reports can be tailored for use by technical operations, by customer support, or by management for planning purposes.

The invention uses data fusion to incorporate relevant secondary external information that was not collected directly from the Internet by means of active or passive monitoring. Such external information may include historical and current data from carriers, enterprises, news media, and others for calibration of accuracy and reliability. The invention uses further external information in various steps of the invention, as illustrated in FIGS. 1 and 3.

Computer System. The invention can be implemented “by hand,” that is, through the use of manual calculations. However, in some aspects, a general purpose computer is programmed to perform the steps described above.

1. A method for determining financial loss related to performance of an internetwork, comprising:
correlating input information regarding performance of an internetwork to operations of a financial entity; and,
translating said correlated input information into a first at least one operational risk for said financial entity.

2. The method recited in claim 1 wherein said internetwork is the Internet.

3. The method recited in claim 1 wherein said internetwork comprises at least one anomaly; and,
said method further comprising:
collecting said input information using techniques that simultaneously record topology and performance;
detecting said at least one anomaly in at least one portion of said internetwork; and,
characterizing said at least one anomaly by type, severity, duration, and effect, wherein said at least one anomaly is selected from the group consisting of denial of service (DoS) attacks, worms, congestion, routing flaps, and other degradation, denial, or disconnection of Internet connectivity.

4. The method recited in claim 1 wherein translating said correlated input information into a first at least one operational risk for said financial entity further comprises calculating a first Probability of Default.

5. The method recited in claim 4 wherein said financial entity comprises a first plurality of customers and calculating said first Probability of Default further comprises:
determining a first customer from said first plurality of customers to be affected by said at least one anomaly; and,
calculating a frequency, severity, and duration of said effect of said at least one anomaly with respect to said first customer.

6. The method recited in claim 1 further comprising:
gathering secondary information, where said secondary information is other than directly from said internetwork;
correlating said input and secondary information; and,
translating said correlated input and secondary information into a second at least one operational risk for said financial entity.

7. The method recited in claim 6 wherein translating said correlated input and secondary information further comprises calculating a first Probability of Default and a Loss Given Default.

8. The method recited in claim 7 wherein said financial entity comprises a second plurality of customers and calculating said second Probability of Default further comprises:
determining a second customer from said second plurality of customers to be affected by said at least one anomaly; and,
calculating a frequency, severity, and duration of said effect of said at least one anomaly with respect to said second customer.

9. The method recited in claim 8 wherein calculating said Loss Given Default further comprises:
for each customer in said second plurality of customers, estimating use of said internetwork to reach said financial entity and estimating a value of said use to said each customer;
combining said estimates of use and said value of said use to estimate a likelihood of said each customer failing to complete a transaction delayed or interrupted by said at least one anomaly; and,
calculating a loss for said financial entity associated with said failing to complete a transaction.

10. The method recited in claim 9 further comprising:
using said Loss Given Default to estimate an Exposure at Default, where said Exposure at Default is a financial loss for said financial entity associated with said at least one anomaly.

11. The method recited in claim 10 wherein said financial entity comprises a third customer with an ongoing contract or account with said financial entity; and,
said method further comprising:
calculating Maturity for said third customer, where said Maturity is a remaining proportion of said ongoing contract or account; and,
wherein using said Loss Given Default to estimate Exposure at Default further comprises combining said second Probability of Default and said Loss Given Default with said Maturity to calculate a long-term component of said Exposure at Default.

12. The method recited in claim 3 further comprising:
aggregating said at least one anomaly over time.

13. The method recited in claim 1 wherein determining a first operational risk further comprises estimating at least one actual effect and at least one probable effect of said operational risk over a time span, aggregating said at least one probable effect, and summarizing said aggregation.

14. The method recited in claim 1 wherein said financial entity is tracking a current state of said internetwork; and,
said method further comprising:
periodically correlating said input information;
periodically translating said periodically correlated input information; and,
providing at least one update regarding said at least one operational risk to said financial entity.

15. The method recited in claim 1 wherein said internetwork comprises a future anomaly and a current anomaly; and,
said method further comprising:
predicting said future anomaly and a progress of said current anomaly.

16. The method recited in claim 1 wherein said financial entity is a bank.

17. A method for determining financial loss related to performance of the Internet, comprising:
collecting input information regarding performance of the Internet using techniques that simultaneously record topology and performance;
detecting at least one anomaly in at least one portion of the Internet, said at least one anomaly selected from the group consisting of denial of service (DoS) attacks, worms, congestion, routing flaps, and other degradation, denial, or disconnection of the Internet connectivity;
gathering secondary information, where said secondary information is other than directly from the Internet;
correlating said input and secondary information to operations of a bank;
translating said correlated input and secondary information into at least one operational risk for said financial entity, said at least one operational risk selected from the group consisting of a probability of default (PD), a loss given default (LGD), an exposure at default (EAD), and a remaining economic maturity (M) of the exposure;
aggregating said at least one anomaly over time;
determining historical performance of a current anomaly among said at least one anomaly;
providing predictions of performance of a future anomaly in the Internet;
reporting details of said at least one anomaly as said at least one anomaly occurs; and,
using said secondary information to calibrate accuracy and reliability of said at least one operational risk.

18. A system for determining financial loss related to performance of an internetwork, comprising:
means to correlate input information regarding performance of an internetwork to operations of a financial entity; and,
means to translate said correlated input information into a first at least one operational risk for said financial entity, where said means to correlate and means to translate are located in at least one specially-programmed general purpose computer.

19. The system recited in claim 18 wherein said internetwork is the Internet.

20. The system recited in claim 18 wherein said internetwork comprises at least one anomaly; and,
said system further comprising:
means to collect said input information using techniques that simultaneously record topology and performance;
means to detect said at least one anomaly in at least one portion of said internetwork; and,
means to characterize said at least one anomaly by type, severity, duration, and effect,
where said means to collect, said means to detect, and said means to characterize are located in said general purpose computer.

21. The system recited in claim 18 wherein said means to translate said correlated input information into a first at least one operational risk for said financial entity further comprises a means to calculate a first Probability of Default.

22. The system recited in claim 18 further comprising:
means to gather secondary external information, where said secondary external information is other than directly from said internetwork;
means to correlate said input and secondary external information; and,
means to translate said correlated input and secondary external information into a second at least one operational risk for said financial entity, where said means to gather, said means to correlate, and said means to translate are located in said at least one general purpose computer.

23. The system recited in claim 22 wherein said means to translate said correlated input and secondary information further comprises a means to calculate a second Probability of Default, a Loss Given Default, an Exposure at Default, and a Maturity.
